(19) United States
(12) Patent Application Publication
(10) Pub. No.: US 2009/0288040 A1
(43) Pub. Date: Nov. 19, 2009

(54) METHOD, SYSTEM AND STORAGE DEVICE FOR AN EMBEDDED COMMAND DRIVEN INTERFACE WITHIN A GRAPHICAL USER INTERFACE

(75) Inventor: Russell Wilson, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: NETQOS, INC, Austin, TX (US)

(21) Appl. No.: 12/425,510

(22) Filed: Apr. 17, 2009

Related U.S. Application Data
(60) Provisional application No. 61/045,853, filed on Apr. 17, 2008.

(51) Int. Cl. G06F 3/048

(52) U.S. Cl. 715/846

(57) ABSTRACT

A command line interface that is imbedded within a program can be implemented to any graphical user interface. An exemplary storage medium that is coupled to the processor such that the processor can read information from, and write information to, the storage medium. Herein, a method and system for providing an imbedded command line interface from within a program's graphical user interface that allows repetitive tasks to be more easily automated without the use of a mouse. The data can be formatted and filtered with only keyboard interaction such that command sequences are flexible and can be reused in the future. The method and system enable easier access to commands requiring multiple clicks and quicker command input over existing graphical user interfaces. In exemplary embodiments of the present invention, the technical user can more easily share and distribute command routines and more easily diagnose issues.

### REFERENCE TO RELATED APPLICATION

This application claims the benefit of priority to U.S. Provisional Patent Application Ser. No. 61/045,853 entitled “METHOD, SYSTEM AND STORAGE DEVICE FOR AN EMBEDDED COMMAND DRIVEN INTERFACE WITHIN A GRAPHICAL USER INTERFACE,” by Russell Wilson filed on Mar. 17, 2008, and is incorporated herein by reference in its entirety for all purposes.

### FIELD

The disclosed subject matter relates primarily to systems and methods for entering commands via an embedded command line interface embedded within a graphical user interface.

### BACKGROUND

The vast majority of programs and software currently in existence, and under development, contain a graphical user interface (“GUI”). For non-technical users this type of interface provides a user friendly way for a user to interact with a program. Generally, the GUI is made up of icons (small pictures) that relate in some manner to the command that is issued when the icon is clicked with the mouse. It allows non-technical users to operate programs without the need to memorize strings of characters and commands. However, technical users find switching from a keyboard to a mouse highly cumbersome and inefficient.

Further, the current GUIs make support tasks difficult. When a user is having a technical problem, support personnel must explain to the user how to fix a particular problem. In doing this through a traditional GUI, the support personnel must spend considerable time instructing the user on where to click. If the user accidentally clicks on the wrong icon, it may take a substantial amount of time for the support personnel to determine what the user clicked and how to get the user back to the proper area.

Traditionally, GUIs do not provide a simple way of entering multiple commands. Some GUIs do allow a programming language in order to enter multiple commands, commonly referred to as macros; however, entering, changing, and correcting these macros are relatively complex. This limitation also inhibits the transfer of these multiple commands to other users.

Many users run certain queries over and over. For example, the same report every month. These queries routinely require customization; however, with current GUIs, users are forced to repeatedly click several icons to recreate the queries such that the queries output is the same each time.

Additionally, very complex click sequences are difficult to remember and even harder to replicate efficiently.

Finally, it is difficult to instruct other users on how to recreate a certain click sequence such that multiple users can receive the same output.

### BRIEF SUMMARY

There is a need for a method, system, and/or storage device that allows technically advanced users to quickly and efficiently enter commands through an embedded command line interface that is embedded within a program.

One aspect of the disclosed subject matter is to provide an embedded command line interface from within a program's GUI.

Another aspect of the disclosed subject matter is to provide a utility that allows for easier and more efficient command scripting.

An additional aspect of the disclosed subject matter is to provide a utility that allows for quicker command input over existing GUIs.

Yet another aspect of the disclosed subject matter is to provide a utility for support personnel to more easily provide users with commands to diagnose and/or address their issues.

An additional aspect of the disclosed subject matter is to allow repetitive tasks to be more easily automated.

An additional aspect of the disclosed subject matter is to allow easier access to commands that would otherwise require multiple clicks.

Yet another aspect of the disclosed subject matter is to provide an input utility that does not require the use of the mouse.

An additional aspect of the disclosed subject matter is to allow users to more easily and efficiently share and distribute command routines.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims to be filed with any regular utility patent application claiming priority based on this provisional filing.

### BRIEF DESCRIPTIONS

The features, nature, and advantages of the disclosed subject matter will become more apparent from the detailed description set forth below when taken in conjunction with the accompanying drawings, wherein:

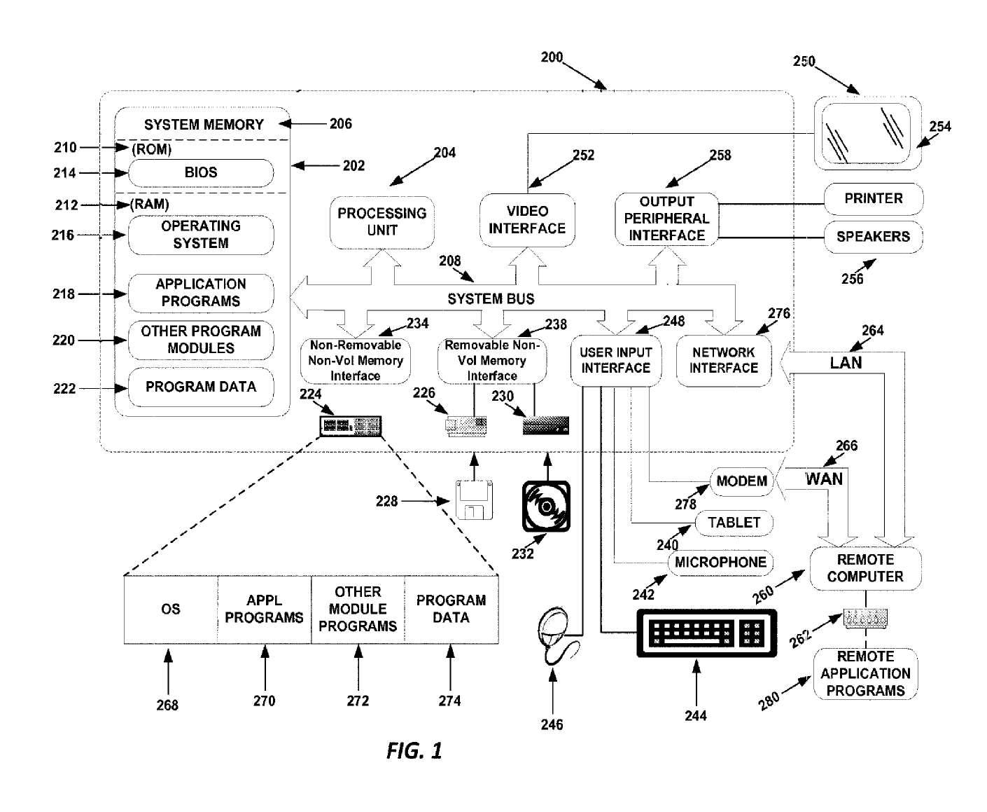

FIG. 1 illustrates a computer system and related peripherals that may operate with the job posting and matching service of the present embodiment.

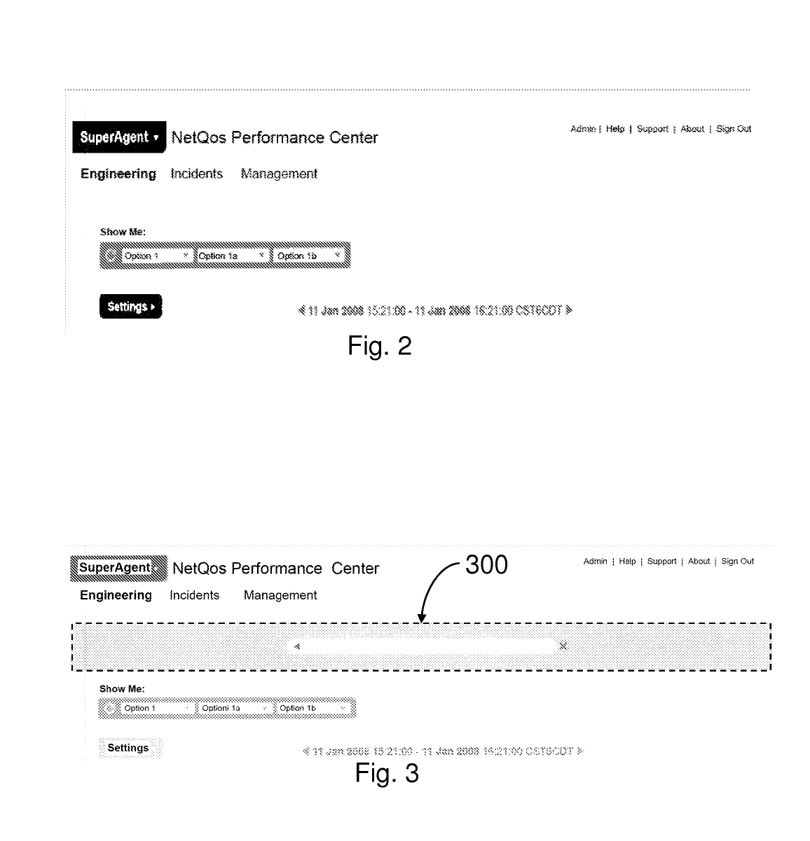

FIG. 2 shows a screen shot of the SuperAgent™ program before activating the embedded command line interface of the present embodiment.

FIG. 3 shows a screen shot of the SuperAgent™ program after activating the embedded command line interface of the present embodiment.

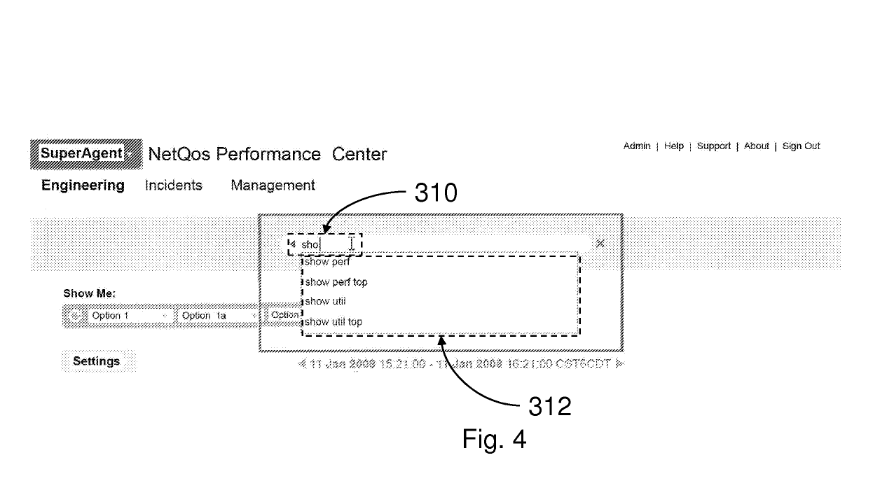

FIG. 4 shows a screen shot of a command being entered into the embedded command line interface of the preferred embodiment.

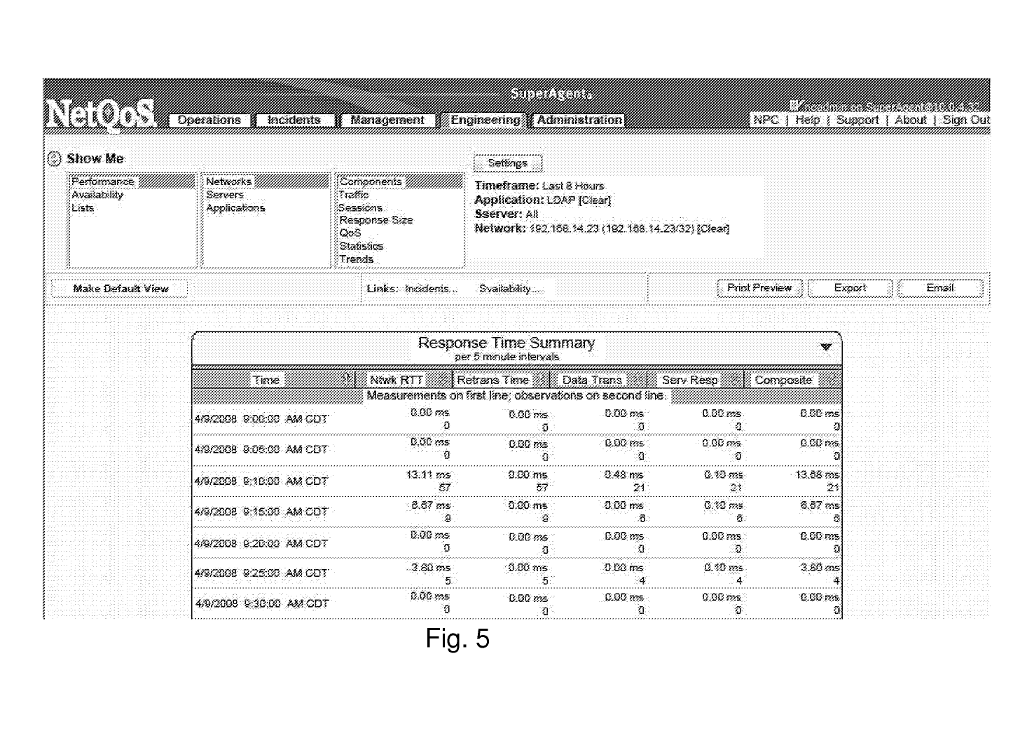

FIG. 5 shows a screen shot of the output from a command entered into the embedded command line interface of the preferred embodiment.

### DETAILED DESCRIPTION OF ILLUSTRATIVE EMBODIMENTS

Although described with reference to specific embodiments, one skilled in the art could apply the principles discussed herein to other areas and/or embodiments.

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

Many technical users find the transition to GUIs to be slow, cumbersome, and frustrating; however, this is clearly the direction the industry is moving. The described subject matter intends to provide these technical users with an alternative interface to the stock GUI provided with most software packages. The disclosed subject matter is intended to be embedded within a GUI and allow technical users the ability to use an embedded command line interface where the technical users can enter commands via a keyboard thereby entering commands faster than using only the mouse or a hybrid of the keyboard and mouse. The described subject matter will be best understood by reference to how it may work from within a particular program's GUI.

Therefore, generally, the below descriptions reference the SuperAgent™ program.

FIG. 2 shows a screen shot of the SuperAgent™ program before activating the embedded command line interface of the present embodiment. FIG. 3 shows a screen shot of the SuperAgent™ program after activating the embedded command line interface of the present embodiment. Specifically, the interface 300 is shown as an input box. Although pictured here as a single line, it is intended to also include a window or box with more than one line. In the preferred embodiment, the embedded command line interface could be activated by a predefined key sequence (e.g. ctrl+Q). FIG. 4 shows a screen shot of a command being entered into the embedded command line interface of the preferred embodiment. In the preferred embodiment, as the user types in a command 310, similar commands would appear in a list below 312. This is intended to facilitate the user in entering commands and the user could select any of those commands by either using the mouse, or using the arrow keys to scroll down and select the desired command. Also, this “suggesting” of commands aids command recall and communicating command options users may not have previously been aware of.

### Basic Commands

The following table gives descriptions of the broad categories of commands available to the disclosed subject matter:
command: built-in atomic command that may or may not require parameters (e.g. “set app http”)
sequence: named saved set of commands executed in order/sequentially (e.g. “ShowPerfTable” could execute several commands that were previously saved with the name ShowPerfTable)
parallel: named saved set of commands executed in parallel (e.g. “show perf | show avail” would pull up both views simultaneously without waiting for one or the other to finish processing)
   Further, the execution capabilities include:
execute a command
execute a sequence
execute a parallel
execute any combination of the above in sequence or in parallel (i.e. sequences can be combined just like commands, as well as parallels, commands and sequences/parallels)
name and save (for later reuse) any of the above including commands which can be given user defined aliases (their own names for the single atomic commands)

The tables below show some of the commands that could be implemented through the embedded command line interface of the present embodiment with specific reference to the SuperAgent™ program.

| | |
|---|---|
| Set [ATTRIBUTE] [VALUE] | |
| Examples: | |
| set time 2 | sets start time to 02:00 of current day |
| set time 2 13:30 | sets start time to 02:00 and end time |
| | to 13:30 of current day |
| set date 24-mar-08 | sets date to 24-Mar-2008 |
| set date tomorrow | sets date to tomorrow (25-Mar-2008) |
| set app http | sets current app to HTTP |
| set metric nrtt | sets current metric to NRTT |
| set net 192.168.0.2/24 | sets current subnet to 192.168.0.2/24 |
| set server 192.168.0.14 | sets server to 192.168.0.14 |
| set homepage | sets current page as the |
| | homepage/default page |
| Show [PARAMETER] | |
| Examples: | |
| show perf | show default performance map (right now |
| | “performance by network”) |
| show perf http | show performance map for http |
| show avail | show availability tables for all |
| show avail dns | show availability for DNS |
| show net list | show network list |
| show net incidents | show incidents by network |
| show avail sla | show the availability SLA list |
| show scorecard | show the performance scorecard |
| Search [PARAMETER] | |
| Examples: | |
| search 192.168.0.2/24 | return NQsearch results for |
| | 192.168.0.2/24 |
| 192.168.0.2/24 | return NQsearch results for |
| | 192.168.0.2.24 |
| Utilities | |
| Examples: | |
| copy | copy current view(s) to clipboard |
| export | export current view(s) to CSV |
| print | print current view(s) to PDF |
| help | open help files |
| admin | go to the admin pages |
| investigations | go to the investigations page |
| overview | go to the operations overview page |
| homepage | open current homepage |
| support | open support page |
| about | open about page |
| sign out | signs out of SuperAgent ™ |

To better show the functionality and desirability of the disclosed subject matter, it is easiest to reference a particular example. For example, if the user entered the following command:
show perf; set app ldap; set net 192.168.14.23; set time last 8 hours; format table.
   The output could be as displayed in FIG. 5. To get the exact same table formatted in the same manner would take the following mouse clicks:
1) User navigates to “Performance”
2) User navigates to “Application”
3)*If* “ldap” is visible in “Performance by Application” table, user clicks it; otherwise user must click “Settings” and select “ldap” from the list of applications
4) To then filter by network, user clicks “Network” and if “192.168.14.23” is visible in “Performance by Network” table, user clicks it; otherwise user must click “Settings” and select “192.168.14.23” from the list of networks
5) User clicks “Settings” to select “Last 8 Hours” for the timeframe
6) User clicks blue arrow drop down menu on view to reformat component graphs to table
   This example shows just a small glimpse into the efficiency gains of the disclosed subject matter.

Given the example above, a user can quickly navigate directly to the data they need, and format and filter the data in a fraction of the time that would otherwise be needed. Moreover they can save and/or share/distribute the command sequence for reuse in the future to pull up the same table. Furthermore, the order of command sequences is more flexible. For example, the above command sequence could also be entered as follows to accomplish the same result:
set time last 8 hours; format table; set app ldap; set net 192.168.14.23; show perf

The above examples also show the functionality of using the disclosed subject matter as a support tool. It is far easier for support personnel to tell a user what to type (or even transmit) the exact command a user is to type than to attempt to guide a user through multiple clicks. Further, the support personnel could use pre-prepared command sequences to help the support personnel identify problems.

In addition to the above disclosed embodiments, the embedded command line interface could also be used to act as a “pipe” to accept and then transmit commands for other command-driven products or devices such as Cisco™ routers.

In addition to providing the same functionality of a programs GUI, the embedded command line interface could also provide capabilities not available in the GUI.

Although many of the commands above reference a specific program, this disclosure is intended to cover any program or application. Further, the above command tables are only examples of some of the functionality of the disclosed subject matter and are not all inclusive. In fact, any command, or sequence of commands, that could be performed by a program could be included.

Those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

What is claimed is:

1. A system for efficiently entering commands for use with a graphical user interface (GUI), the system comprising:
a graphical user interface (GUI) embedded on a computer readable storage medium, said GUI for exposing user interaction through program icons; and
an embedded command line interface programmatically coupled to said GUI, said embedded command line interface enabling the input of character strings exposing a programmatic functionality.
